(19) United States
(12) Patent Application Publication
(10) Pub. No.: US 2008/0229258 A1
(43) Pub. Date: Sep. 18, 2008

(54) Navigable screensaver and method for implementing same

(75) Inventor: Scott Watson, Marina Del Rey, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: Disney Enterprises, Inc.

(21) Appl. No.: 11/724,519

(22) Filed: Mar. 14, 2007

(51) Int. Cl. G06F 3/048

(52) U.S. Cl. 715/867

(57) ABSTRACT

There is provided a method for use by a computer for implementing a navigable screensaver. In one embodiment, the navigable screensaver is activated. A user command entered through a user interface of the computer is detected. The navigable screensaver is then maintained to allow a user to navigate the navigable screensaver. The user command is executed by requesting content from a server through a network. Thereafter, the content is received for display in the navigable screensaver. The content is then displayed in the navigable screensaver. Content specified by the user is automatically requested and received by the navigable screensaver. Then, a web browser displaying a web page associated with the content selected by the user in the navigable screensaver is initiated.

### BACKGROUND OF THE INVENTION

1. Field of the Invention

The present invention relates generally screensaver applications for computers. More particularly, the present invention relates to a screensaver application that can be navigated by a user.

2. Background Art

A screensaver is a computer application that is initiated during periods when a computer is not in use in order to protect the output display, e.g., the monitor, of the computer. When the screensaver is active, moving patterns and images are typically displayed on the output display to prevent “burn-in” of the image on the output display, which can result if a static image is displayed for prolonged periods.

Conventional screensavers typically initiate automatically after detecting a period of inactivity by a computer and begin to display preselected images and animations. For example, a screensaver may sequentially display images stored in a computer, such as images of a family vacation. As another example, a screensaver may be configured to display an animation of a simulated environment, such as a simulated fish tank including a number of simulated tropical fish. However, such conventional screensavers are limited to repeatedly displaying the same pre-selected content. Moreover, the conventional screensavers typically terminate immediately upon detecting a command from a user. For example, the command can be a mere keystroke on a keyboard or a click of a mouse. As such, conventional screensavers offer very little functionality and few features.

### SUMMARY OF THE INVENTION

There is provided a navigable screensaver and method for implementing same, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 illustrates a block diagram of a computer including a navigable screensaver in accordance with one embodiment of the invention; and

FIG. 2 illustrates a flow diagram of a method for use by a computer for implementing a navigable screensaver in accordance with one embodiment of the invention.

### DETAILED DESCRIPTION OF THE INVENTION

Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

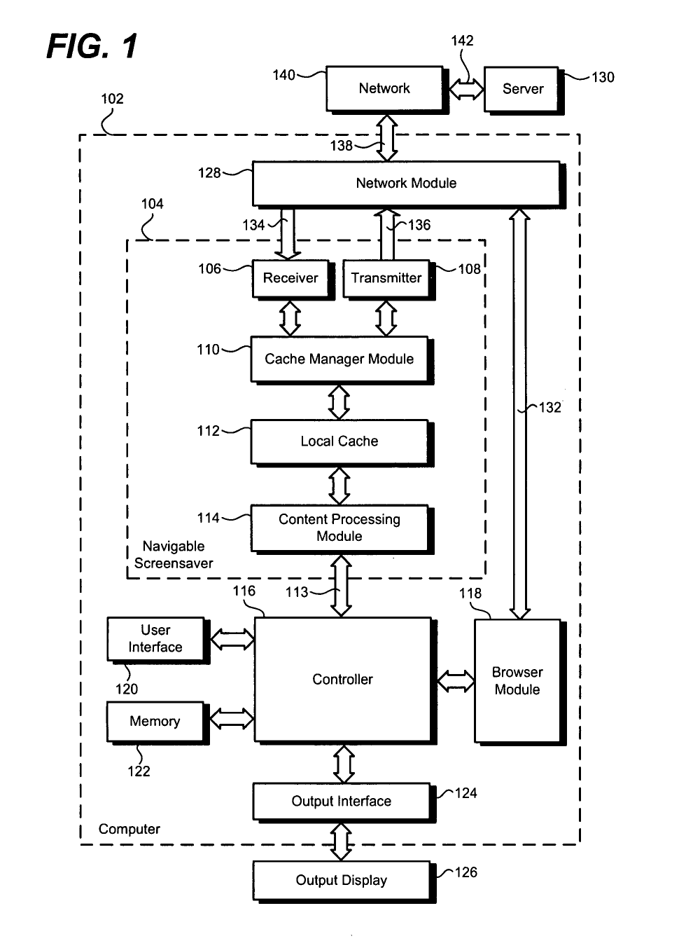

FIG. 1 illustrates a block diagram of a computer including a navigable screensaver in accordance with one embodiment of the invention. As shown in FIG. 1, computer 102 includes navigable screensaver 104, controller 116, browser module 118, network module 128, user interface 120, memory 122, and output interface 124. As also shown in FIG. 1, navigable screensaver 104 includes receiver 106, transmitter 108, cache manager module 110, local cache 112, and content processing module 114.

Computer 102 in FIG. 1 can be, for example, a personal computer or any other type of computer. As shown in FIG. 1, controller 116 is coupled to user interface 120, memory 122, browser module 118, and output interface 124. Controller 116 can be, for example, a microcontroller or a central processing unit (CPU). User interface 120 can be, for example, a graphical user interface (GUI), such as Microsoft Windows, which allows a user to enter commands through an input device, such as a keyboard or mouse. As shown in FIG. 1, user interface 120 can provide suitable output signals to output interface 124, which can be a video card or a display adapter for example, through controller 116. Output interface 124 can then provide the proper video signals to output display 126, which can be a television or computer monitor, for example.

As shown in FIG. 1, network module 128 of computer 102 is in communication with network 140 via data path 138 and can communicate with server 130 through network 140. Server 130 can be, for example, a web server or any other type of server. For example, network module 128 can be an Ethernet adapter. Data path 138, for example, can be a wired connection, such as a physical communication bus, or a wireless connection, such as a wireless local area network (LAN) connection.

As shown in FIG. 1, controller 116 is coupled to navigable screensaver 104 via bus 113. Navigable screensaver 104 can be implemented in hardware or software and can be configured to display content on output display 126. For example, navigable screensaver 104 can be initiated by a user through user interface 120 or can be automatically initiated after a predetermined time period of inactivity by computer 102. As shown in FIG. 1, navigable screensaver 104 can be configured to transmit a request for content to server 130 using transmitter 108 and can be configured to receive content from server 130 using receiver 106. For example, transmitter 108 can be configured to transmit a request for content to network module 128 via bus 136, which can then transmit the request to server 130 via data paths 138 and 142. Receiver 106, for example, can be configured to receive content through network module 128 via bus 134.

As shown in FIG. 1, cache manager module 110 in navigable screensaver 104 is in communication with both receiver 106 and transmitter 108. Cache manager module 110 can be configured to regulate requests for various types of content from servers coupled to a network, e.g., server 130, for display of the content on output display 126. For example, cache manager module 110 can be configured to request content such as videos, images, and Extensible Markup Language (XML) data files. In one embodiment, cache manager module 110 can include a feed reader, thereby enabling it to receive content through a web feed, such as a Really Simple Syndication (RSS) feed. In another embodiment, cache manager module 110 can be configured to request content that includes advertisements and other promotional communications.

After receiving the content, cache manager module 110 can be configured to store the content in local cache 112. By storing the content in local cache 112, cache manager module 110 can avoid transmitting subsequent requests for content previously requested and received. As such, the use of local cache 112 can optimize performance of navigable screensaver 104 by decreasing the time required to access the content and by freeing up network bandwidth. Thus, in one embodiment, cache manager module 110 can be configured to regulate requests for content by examining the contents of local cache 112 and transmitting a request for the content only if the content is not found in local cache 112.

Content processing module 114 in FIG. 1, for example, can receive content stored in local cache 112 and can be configured to render and format the content for display in navigable screensaver 104 on output display 126. For example, content processing module 114 can be configured to play a video file, to display an image, or to display text. In other embodiments, content processing module can be configured to play a video file in an animated three-dimensional object or to display animated textures in the background of navigable screensaver 104. In one embodiment of the invention, navigable screensaver 104 can be configured to allow a user to select the content being displayed in navigable screensaver 104 to initiate a web browser that is configured to display a web page associated with the selected content. As shown in FIG. 1, for example, browser module 118 can be used to display a web page associated with the selected content by accessing network module 128 via bus 132. For example, browser module 118 can be implemented using commercial web browsing applications, such as Microsoft Internet Explorer or Netscape.

In one embodiment, navigable screensaver 104 can be configured to have a theme, such as sports highlights and news, and can be used to promote a web site having a similar theme, such as ESPN.com. In such an embodiment, navigable screensaver 104 can include a graphical background having animated textures promoting ESPN.com and can display images and video of sports highlights and news that might be found on ESPN.com. As described above, navigable screensaver 104 can automatically receive content through a web feed, thereby allowing it to display up to the minute information, such as scores and other breaking news. In such an embodiment, navigable screensaver 104 can be configured to receive and display customized information, such as content associated with a particular sport, e.g., basketball or football, or content associated with a particular sports team. In other embodiments, navigable screensaver 104 can be configured to automatically receive user-specified information from other sources, e.g., other web sites, through a web feed, such as current weather information. Since navigable screensaver 104 can request and receive content from server 130, which can be a web server as discussed above, navigable screensaver 104 can receive and display content from virtually any web site, such as images from flickr.com, or even content from other applications, such as Apple iTunes.

Continuing with the abovementioned embodiment, navigable screensaver 104 can be maintained when a user enters a user command through user interface 120 to allow a user to control the content displayed in navigable screensaver 104. For example, if a user misses a portion of a video displayed in navigable screensaver 104, the user may press a predetermined key on a keyboard, e.g., using interface 120, to instantly replay the video. In contrast, conventional screensavers typically terminate immediately upon receiving a command from a user interface and thus effectively prevent such navigation in the screensavers. As another example, a user interested in a news headline may select the headline using user interface 120, e.g., by clicking a mouse, to receive additional content associated with the news headline. In another embodiment, navigable screensaver 104 can initiate a web browser, which can display a web page associated with the news headline.

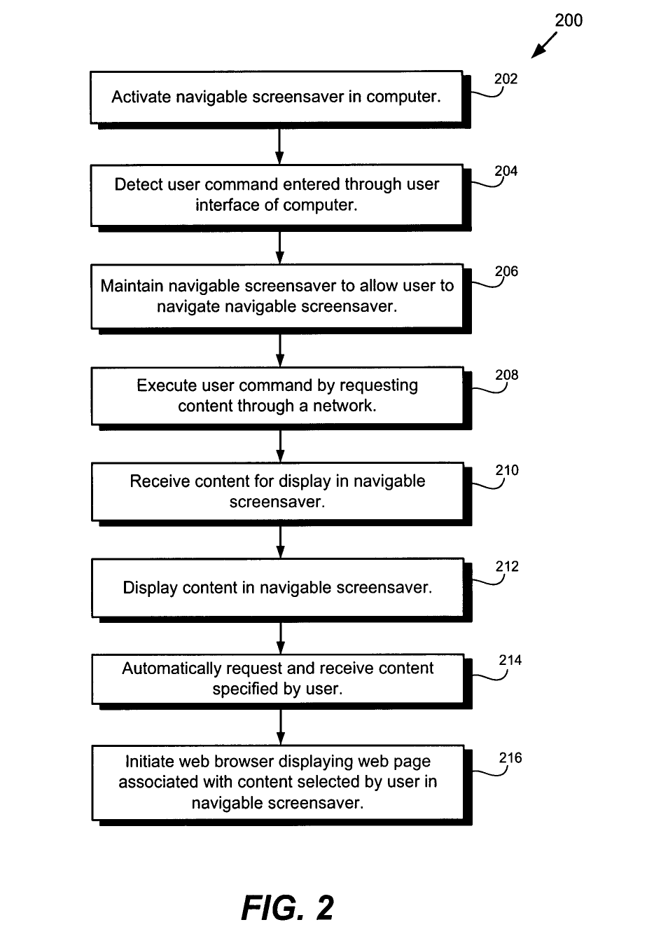

FIG. 2 illustrates a flow diagram of a method for use by a computer for implementing a navigable screensaver in accordance with one embodiment of the invention. With reference to FIG. 1 and as shown in FIG. 2, at step 202 of flowchart 200, navigable screensaver 104 is activated in computer 102. In one embodiment, navigable screensaver is activated automatically when computer 102 has remained inactive for a period of time. The period of time can be any period of time specified by a user and can be, for example, 1.0 minute or 5.0 minutes. In other embodiments, navigable screensaver 104 can be manually activated at any time by a user through user interface 120. At step 204, a user command entered through user interface 120 of computer 102 is detected. At step 206, navigable screensaver 104 is maintained to allow a user to navigate navigable screensaver 104. At step 208, the user command is executed by requesting content from server 130 through network 140. At step 210, the content is received for display in navigable screensaver 104. At step 212, the content is displayed in navigable screensaver 104. At step 214, content specified by a user is automatically requested and received by navigable screensaver 104 for display in navigable screensaver 104. At step 216, a web browser displaying a web page associated with content selected by a user in navigable screensaver 104 is initiated.

Thus, the present invention provides several advantages over conventional screensavers. For example, by maintaining navigable screensaver 104 even after a user enters a user command, the preset invention enables navigation of navigable screensaver 104 by, for example, allowing a user to control the content displayed in navigable screensaver 104. Moreover, since navigable screensaver 104 can request and receive content stored in a server through a network, navigable screensaver 104 can be continuously updated and changed, thereby providing a dynamic and interesting display. As such, navigable screensaver 104 can be used to display up to date content including eye-catching images and videos associated with various websites to increase interest in the websites. Accordingly, navigable screensaver 104 can provide a similar effect for advertisements from third-party suppliers to promote commercial products or services included in the advertisements. Thus, the present invention can be used in a wide variety of computer systems that include output displays or terminals that can be viewed by the public to increase interest in a website or to convey promotional communications.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. For example, it is contemplated that the circuitry disclosed herein can be implemented in software, or vice versa. The described embodiments are to be considered in all respects as illustrative and not restrictive. It should also be understood that the invention is not limited to the particular embodiments described herein, but is capable of many rearrangements, modifications, and substitutions without departing from the scope of the invention.

Thus, a navigable screensaver and method for implementing same has been described.

What is claimed is:

1. A method for use by a computer for implementing a navigable screensaver, said method comprising:
activating said navigable screensaver when said computer is inactive for a period of time;
detecting a user command entered through a user interface of said computer;
maintaining said navigable screensaver after said detecting said user command to allow said user to navigate said navigable screensaver;
executing said user command by requesting content stored in a server;
receiving said content for display in said navigable screensaver;
displaying said content in said navigable screensaver.

2. The method of claim 1 further comprising receiving said content from said server automatically using a feed reader.

3. The method of claim 1 wherein said content is one of a video, a Really Simple Syndication (RSS) feed, Extensible Markup Language (XML) data, or an image.

4. The method of claim 1 wherein said server is a web sever.

5. The method of claim 1 wherein said content includes video highlights of a sporting event.

6. The method of claim 1 further comprising initiating a web browser when said content is selected by said user, wherein said web browser is configured to display a web page associated with said content.

7. The method of claim 1 wherein said navigable screensaver is configured to display said content without having access to said server.

8. The method of claim 1 wherein said content comprises an advertisement.

9. The method of claim 1 wherein said navigable screensaver is configured to display animated textures.

10. The method of claim 1 wherein said content is displayed in an animated three-dimensional object.

11. A navigable screensaver for use in a computer, said navigable screensaver being configured to accept a user command entered by a user, said navigable screensaver comprising:
a cache manager module for regulating requests for content stored in a server;
a receiver for receiving said content;
a local cache for storing said content to optimize performance of said navigable screensaver;
a content processing module for rendering said content for display in said navigable screensaver;
wherein said navigable screensaver is maintained during entry of said user command to allow navigation of said navigable screensaver.

12. The navigable screensaver of claim 11 further comprising a feed reader configured to automatically receive said content from said server.

13. The navigable screensaver of claim 11 wherein said content is one of a video, a Really Simple Syndication (RSS) feed, Extensible Markup Language (XML) data, or an image.

14. The navigable screensaver of claim 11 wherein said server is a web server.

15. The navigable screensaver of claim 11 wherein said content includes video highlights of a sporting event.

16. The navigable screensaver of claim 11 wherein said navigable screensaver is configured to initiate a web browser when said content is selected by said user, wherein said web browser is configured to display a web page associated with said content.

17. The navigable screensaver of claim 11 wherein said navigable screensaver is configured to display said content without having access to said server.

18. The navigable screensaver of claim 11 wherein said content comprises an advertisement.

19. The navigable screensaver of claim 11 wherein said navigable screensaver is configured to display animated textures.

20. The navigable screensaver of claim 11 wherein said content is displayed in an animated three-dimensional object.
